(19) United States
(12) Patent Application Publication
(10) Pub. No.: US 2009/0208708 A1
(43) Pub. Date: Aug. 20, 2009

(54) CARBON-NANOTUBE ARRAYS, YARNS, FILMS AND COMPOSITES, AND THE METHODS FOR PREPARING THE SAME

(76) Inventors: Fei Wei, Beijing (CN); Qiang Zhang, Beijing (CN); Weiping Zhou, Beijing (CN); Weizhong Qian, Beijing (CN)

Correspondence Address: XIN WEN, 3449 RAMBOW DRIVE, PALO ALTO, CA, 94306, US

(21) Appl. No.: 12/430,265

(22) Filed: Apr. 27, 2009

Related U.S. Application Data
(63) Continuation of application No. PCT/CN2007/003177, filed on Nov. 9, 2007.

(30) Foreign Application Priority Data
Nov. 10, 2006 (CN) 200610114426.5

(51) Int. Cl. D02G 3/02; D01F 9/12; B32B 1/00; D02J 1/22; B32B 5/08; B32B 27/06

(52) U.S. Cl. 428/174; 423/447.1; 264/164; 264/145; 264/103; 428/220; 428/367; 428/408

(57) ABSTRACT

Carbon-nanotube arrays, yarns, films and composites, and the methods for preparing the same are provided. The substrate used is non-flat and has a radius of curvature of at least about 10 μm. The length of the carbon-nanotube yarns and films is at least about 1 cm. The method for preparing the carbon-nanotube composites includes the step of contacting a carbon-nanotube yarn or film with a polymer.

### RELATED APPLICATIONS

The present application is a national-entry application based on and claims priority to PCT Patent Application PCT/CN2007/003177, entitled “Carbon-nanotube arrays, yarns, films and composites, and the methods for preparing the same” by the same inventors, filed Nov. 9, 2007, which claims priority to Chinese Patent Application No. 200610114426.5 filed Nov. 10, 2006. The content of these applications is incorporated herein by reference.

### BACKGROUND

The present disclosure relates to carbon nanotube arrays, yarns, films, and composites, and methods of making such.

Carbon nanotubes (CNT) have many unique properties stemming from small sizes, cylindrical structure, and high aspect ratios. A single-walled carbon nanotube (SWCNT) consists of a single graphite sheet wrapped around to form a cylindrical tube. A multi-walled carbon nanotube (MWCNT) includes a set of concentrically single layered nanotube with a horizontal cross-section like the ring of a tree trunk. Carbon nanotubes have extremely high tensile strength (˜150 GPa), high modulus (˜1 TPa), large aspect ratio, low density, good chemical and environmental stability, and high thermal and electrical conductivity. Carbon nanotubes have found various applications, including the preparation of conductive, electromagnetic and microwave absorbing and high-strength composites, fibers, sensors, field emission displays, inks, energy storage and energy conversion devices, radiation sources and nanometer-sized semiconductor devices, probes, and interconnects, etc.

Various types of carbon nanotubes have been prepared. A continuous mass production of carbon nanotubes agglomerates can be achieved using a fluidized bed, mixed gases of hydrogen, nitrogen and hydrocarbon at a low space velocity (WO 02/094713; US Patent Pub. No. 2004/0151654). The carbon-nanotube arrays can be obtained in large scale by floating catalyst methods on a particle surface (Chinese Patent Pub. No. 1724343A). However, due to the limited length of single carbon nanotubes, it is very difficult to manipulate the carbon nanotubes at a microscopic level. Therefore, assembly of carbon nanotubes into macroscopic structures is of great importance to their applications at the macroscopic level.

The carbon-nanotube array has been obtained by thermal Chemical Vapor Deposition (CVD) and spun into yarns (see, Jiang et al. Chinese Patent Publication No. CN 1483667A). One direct method for the preparation of macroscopic carbon nanotubes involves the synthesis of carbon-nanotube array on silicon wafers using pre-deposited nano-catalyst-film by thermal CVD and subsequent obtaining carbon-nanotube yarns by spinning from the carbon-nanotube arrays. The process is, however, costly and difficult to scale up. The other approach is to obtain carbon-nanotube ropes directly from a floating catalyst process. Nevertheless, the carbon-nanotube yarns obtained by this process have low purity and poor physical properties.

Therefore, there is a need to develop other methods and carbon nanotubes intermediates suitable for the facile and low cost production of carbon-nanotube yarns, films and composite which are suitable for macroscopic applications of carbon nanotubes.

### SUMMARY

The present invention provides a carbon-nanotube structure including an array of aligned carbon-nanotube on a substrate and methods for preparing carbon-nanotube yarn, film and composite. In one embodiment, the methods provide super-long and oriented carbon-nanotube yarn and film. Advantageously, the carbon nanotubes are grown on thermally stable and high temperature resistant substrates, such as silicon, SiO₂, aluminum oxide, zirconium oxide, and magnesium oxide, which permit the substrates to be transferred in and out of the reactor with ease. Such features are suitable for large-scale production of aligned carbon nanotubes. In addition, the dimension of the drawn carbon-nanotube yarn or film can be controlled by using drawing tools and adjusting the initial shape of the carbon-nanotube bundles. For example, the length of the carbon-nanotube yarn or film can be controlled to allow the preparation of carbon-nanotube yarn or film longer than 1 cm. In one embodiment, the present invention provides methods of preparing ultra long carbon-nanotube yarn while maintaining the carbon nanotubes in substantially the same orientations. For example, the carbon-nanotube yarn is more than several hundred meters long.

In one aspect, the present invention provides a carbon nanotube structure. The structure includes an array of substantially aligned carbon nanotubes deposited on a substrate, wherein the substrate has a radius of curvature of at least about 10 μm.

In another aspect, the present invention provides a method for preparing an array of substantially aligned carbon-nanotubes. The method includes providing a reactor having a substrate disposed in the reactor for growing carbon nanotubes, and reacting a carbon source and a catalyst in the reactor under conditions sufficient to form an array of substantially aligned carbon nanotubes on the substrate, wherein the substrate has a radius of curvature of at least about 10 μm. In one embodiment, the substrate has a non-flat surface. In one embodiment, the reactor can host one or more substrates for the CNT growth and supply a reaction mode for decomposing a carbon source by a catalyst under a suitable condition.

In another aspect, the present invention provides a method for preparing a carbon-nanotube yarn. The method includes forming an aligned carbon-nanotube array deposited on a substrate and drawing a bundle of carbon nanotubes from the array of carbon nanotubes to form a carbon-nanotube yarn, wherein the substrate has a radius of curvature of at least about 10 μm and the array of aligned carbon nanotubes can be optionally separated from the substrate.

In yet another aspect, the present invention provides a method for preparing a carbon-nanotube film. The method includes forming an aligned carbon-nanotube array deposited on a substrate and drawing multiple or a plurality of bundles of carbon nanotubes from the array of carbon nanotubes to form a carbon-nanotube film, wherein the substrate has a radius of curvature of at least about 10 μm and the array of aligned carbon nanotubes can be optionally separated from the substrate.

In one embodiment, the aligned carbon-nanotube array can be form by providing a reactor having a substrate disposed in the reactor for growing carbon nanotubes and reacting a carbon source and a catalyst in the reactor under conditions sufficient to form an array of aligned carbon nanotubes on the substrate, wherein the substrate has a radius of curvature of at least about 10 μm.

In still another aspect, the present invention provides a method of preparing a carbon-nanotube composite. The method includes contacting a carbon-nanotube yarn with a polymer under conditions sufficient to form a carbon-nanotube composite, wherein the polymer is deposited on the carbon-nanotube yarn.

Although the invention has been particularly shown and described with reference to multiple embodiments, it will be understood by persons skilled in the relevant art that various changes in form and details can be made therein without departing from the spirit and scope of the invention.

### BRIEF DESCRIPTION OF THE DRAWINGS

The following drawings, which are incorporated in and form a part of the specification, illustrate embodiments of the present invention and, together with the description, serve to explain the principles of the invention.

FIG. 1 shows an SEM image of the spinnable carbon-nanotube arrays obtained from a floating catalyst process.

FIG. 2 illustrates a schematic diagram for the spinning carbon-nanotube yarn, yarn or film drawn from a carbon-nanotube array according to the present disclosure.

FIG. 3 shows an SEM image of the carbon-nanotube yarn according to the present disclosure.

FIG. 4 shows an SEM image of a carbon-nanotube film according to the present disclosure.

### DETAILED DESCRIPTION

As used herein, the term “yarn” means a continuous strand of several monofilaments or fibers. This strand often contains two or more plies that are composed of carded or combed fibers twisted together by spinning, filaments laid parallel or twisted together. For example, a yarn can be a one centimeter to a few meters long.

As used herein, the term “fiber” means consisting of one monofilament.

As used herein, the term “composite” means a product comprising at least one polymer and carbon nanotubes as fillers or vice versus.

As used herein, the term “alkane” means, unless otherwise stated, a straight or branched chain hydrocarbon, having the number of carbon atoms designated (i.e. C₁₋₈ means one to eight carbons). Examples of alkane include methane, ethane, n-propane, isopropane, n-butane, t-butane, isobutene, sec-butane, n-pentane, n-hexane, n-heptane, n-octane, and the like.

As used herein, the term “alkene” refers to a linear or a branched hydrocarbon having the number of carbon atoms indicated in the prefix and containing at least one double bond. For example, C₂₋₆ alkene is meant to include ethylene, propylene, 1-butene, trans-but-2-ene, cis-but-2-ene, isobutene ethane, propane, and the like.

As used herein, the term “alkyne” refers to a linear or a branched monovalent hydrocarbon containing at least one triple bond and having the number of carbon atoms indicated in the prefix. Examples of alkyne include ethyne, 1- and 3-propyne, 3-butyne and the like.

As used herein, the term “alkyl”, by itself or as part of another substitute, means, unless otherwise stated, a straight or branched chain hydrocarbon radical, having the number of carbon atoms designated (i.e. C₁₋₈ means one to eight carbons). Examples of alkyl groups include methyl, ethyl, n-propyl, isopropyl, n-butyl, t-butyl, isobutyl, sec-butyl, n-pentyl, n-hexyl, n-heptyl, n-octyl, and the like.

As used herein, the term “arene” means an aromatic hydrocarbon, which can contain a single ring or multiple rings or fused rings. Examples of arene include benzene, biphenylene, naphthalene, anthracene and the like.

As used herein, the term “halogen” means a fluorine, chlorine, bromine, or iodine atom.

The present invention provides an array of substantially aligned carbon-nanotubes deposited or assembled on a substrate and methods for the preparation of an array of substantially aligned carbon-nanotubes, a yarn of carbon-nanotubes, a film of carbon-nanotubes, and composite including carbon-nanotubes. Advantageously, the present invention allows the facile synthesis of highly aligned carbon-nanotube arrays on a substrate using various catalytic processes, including floating catalyst process. The invention also allows the manufacture of carbon-nanotube yarn, yarn and film using a drawing process. The dimensions of the carbon-nanotube yarn, yarn or film can be readily controlled. Carbon-nanotube composite materials can also be prepared readily by mixing a polymer and a carbon-nanotube yarn or film. In addition, the present invention has provided useful processes for large-scale production of aligned carbon-nanotube arrays, yarns or films.

In one aspect, the present invention provides a carbon-nanotube structure including an array of aligned carbon nanotubes deposited or assembled on a substrate, for example, the carbon nanotubes can aligned vertically. The substrate can have a radius of curvature of greater than about 1 μm, preferably greater than 5 μm. More preferably, the substrate has a radius of curvature of at least about 10 μm. In one embodiment, the substrate has a radius of curvature greater than 10 μm, but is a non-flat surface. For instances, the radii of curvature of the substrates can be greater than or equal to 10, 15, 20, 25, 30, 35, 40, 45, 50, 55, 60, 65, 70, 75, 80, 85, 90, 95, 100, 200, 300, 400, 500, 600, 700, 800, 900 or 1000 μm. The aligned carbon nanotubes can have a diameter from about 1 nm to about 200 nm and a length greater than about 0.01 mm. An exemplary length of aligned carbon nanotubes is between about 0.01 mm to about 50 mm. For example, the carbon nanotubes can have a diameter of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 90, 91, 92, 93, 94, 95, 96, 97, 99, 100, 110, 120, 130, 140, 150, 160, 170, 180, 190, 200, 300, 400, 500, 600, 700, 800 or 900 nm. In one embodiment, the aligned carbon nanotubes can have a length of about 0.1, 0.2, 0.3, 0.4, 0.5, 0.6, 0.7, 0.8, 0.9, 1.0, 2, 3, 4, 5, 6, 7, 8, 9, 10, 15, 20, 25, 30, 35, 40, 45, 50, 55 and 60 mm. The substrates can have either smooth or rough surfaces.

Various substrates can be used for growing carbon nanotubes. The substrates can have different forms. The substrate can have planar, smooth or curved surfaces, preferably, the substrate has a non-flat surface with a radius of curvature not less than 10 μm. The substrate with the non-flat surface offers significant advantages over flat and smooth surface with regard to the mass production of carbon-nanotube arrays. For example, the substrate with the curved surface allows the growth of more carbon nanotubes per volume surface area. The nanotubes grown on the curved surface also facilitate the drawing out yarns or films with controlled dimensions. In general, when a flat and smooth substrate is used, super-aligned carbon nanotubes are necessary for drawing out a yarn. Certain problems, such as entanglement may exist when drawing on carbon-nanotube arrays not being super aligned. When curved surface is used, high quality elongated yarn and films can be readily drawn with aligned carbon nanotubes. The stringent super alignment requirement of the carbon-nanotubes for drawing is not needed. In certain instances, the substrates used can be spherical, tubular, curved plate or combinations of different shapes. The substrates can have regular or irregular shapes. The substrates can have surfaces with a constant radius of curvature or variable radius of curvature at different locations of the substrate surface. The materials suitable for use as substrates include, but are not limited to, silicon, silica, alumina, zirconia, magnesia, quartz and combinations thereof. Non-limiting exemplary substrates include a curved silicon plate, a silicon particle, a silicon fiber, a silica plate, a SiO₂/ZrO₂ sphere, a quartz fiber, a quartz tube, a quartz particle, an alumina plate, an alumina particle, a magnesia particle and a magnesia plate. The particles can also have different shapes and sizes, for example, spherical, cubical, cylindrical, discoidal, tabular, ellipsoidal or irregular. The fibers can have different cross-sections, such as square, rectangular, rhombus, oval, polygonal, trapezoidal or irregular. Different types of substrates can be used within a single reactor.

The present invention also provides carbon-nanotube films. The films are composed of an array of aligned carbon-nanotube yarns. The films of various dimensions can be prepared. In one embodiment, the films have a width from about 10 μm to about 50 cm, such as 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 90, 91, 92, 93, 94, 95, 96, 97, 99, 100, 101, 102, 103, 104, 105, 106, 107, 108, 109, 200, 250, 300, 350, 400, 450, 500, 550, 600, 650, 700, 750, 800, 850, 900, 1000, 1500, 2000, 2500, 3000, 4000, 5000, 6000, 7000, 8000, 9000, 10000, 20000, 30000, 40000, 50000, 60000, 70000, 80000, 90000, 100000, 20000, 30000, 40000, 50000 μm.

In another embodiment, the film have a thickness from about 20 to about 900 nm, for example, about 20, 30, 40, 50, 60, 70, 80, 90, 100, 200, 300, 400, 500, 600, 700, 800, or 900 nm. The films can have any desirable length from one centimeter to hundreds of meters. Exemplary length of the film can be from about 1 cm to about 900 cm.

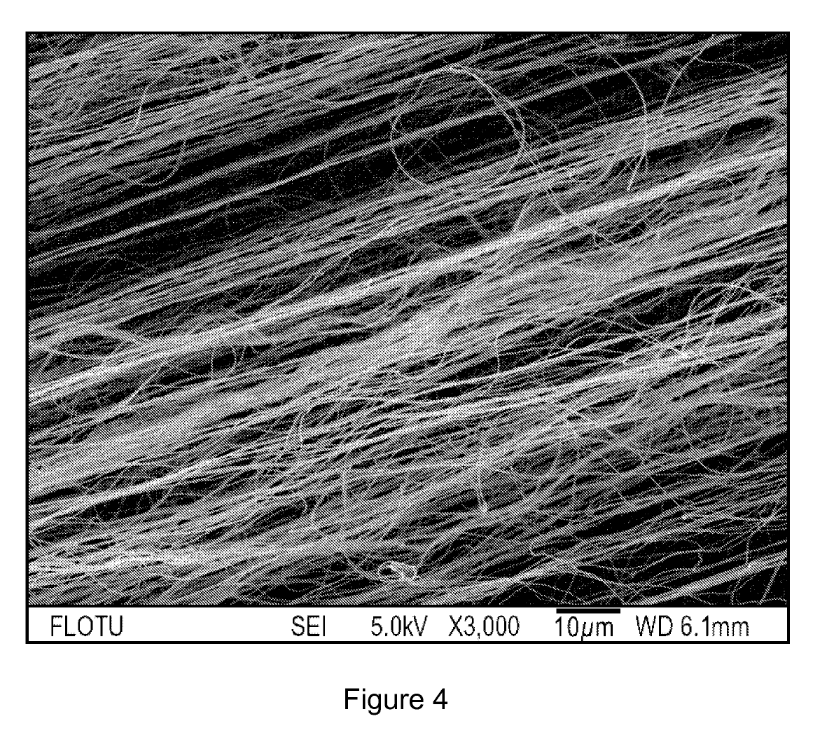

FIG. 4 illustrates an elongated carbon-nanotube film according to an embodiment of the invention. The film is composed of multiple bundles interconnected carbon nanotubes. The orientation of all the carbon nanotubes is substantially the same. The film has a thickness of greater than about 10, 20, 30, 40, 50, 60, 60, 70, 80 or 90 nm; a width greater than about 10, 20, 30, 40, 50, 60, 70, 80, 90 or 100 μm; and a length greater than 1, 10, 100, 1000, 10000, 100000 cm.

In another aspect, the present invention provides a method for preparing an array of aligned carbon nanotubes. The method includes providing a reactor having a substrate disposed in the reactor for growing carbon nanotubes and carbon source decomposing by catalyst in the reactor under conditions sufficient to form an array of aligned carbon nanotubes on the substrate, wherein the substrate has a radius of curvature of at least about 10 μm.

Various reaction vessels and furnaces can be used for carrying out the reaction. In one embodiment, suitable reactors used include, but are not limited to, a fluidized-bed reactor, a spout-bed reactor, a horizontal drum, a moving-bed reactor, a fixed-bed reactor, a multistage reactor and combinations of different reactors. Preferably, the reactor is a fluidized-bed reactor. The substrate can be placed at any locations within the reactor, for example, the substrate can be placed at the bottom, the top or middle sections of the reactor. In one embodiment, the substrate is placed at the bottom of an upright reactor.

Typically, a carbon source is carbon monoxide, a hydrocarbon compound or a mixture thereof. The carbon source can be purified or unpurified carbon containing compounds, such as hydrocarbons. The hydrocarbon compound can be gas, liquid or solid at ambient temperature. In one embodiment, the hydrocarbon is a gas or a liquid. Non-limiting carbon source includes CO, alkanes, alkenes, alkynes, aromatic compounds or mixtures thereof. In one embodiment, the carbon source is CO, or a hydrocarbon compound selected from the group consisting of a C₂₋₁₂ alkene, a C₂₋₁₂ alkyne, and an arene having from 6 to 14 ring carbons or mixtures thereof, wherein the arene is optionally substituted with from 1-6 C₁₋₆ alkyl. In one instance, the carbon source is arene selected from the group consisting of optionally substituted benzene, biphenylene, triphenylene, pyrene, naphthalene, anthracene and phenanthrene or mixtures thereof. In another embodiment, the carbon source is a C₁₋₄ hydrocarbon gas, such as methane, ethane, propane, butane, propylene, butylene or mixtures thereof.

Various single component and multiple components metal catalysts can be used for the formation of aligned carbon nanotubes. Exemplary metals include Fe, Ni and Co. In one embodiment, the catalysts contain a second metal component. Non-limiting exemplary second metal includes, Fe, Ni, Co, V, Nb, Mo, V, Cr, W, Mn and Re. The active metal catalysts are typically generated in situ, for example, from metal catalyst precursors through a reduction or thermal decomposition process. The active metal catalysts are present as metal nanoparticles. The reduction process involves the reduction of the metal catalyst precursors to produce the active metal nanoparticles. As such, in one embodiment, the active metal catalysts are metal nanoparticles including iron and optionally at least one metal selected from the group consisting of Ni, Co, V, Nb, Ta, Zr, Cu, Zn, Mo, V, Cr, W, Mn and Re. In another embodiment, the active metal catalysts are metal nanoparticles including nickel or cobalt and optionally at least one metal selected from the group consisting of Fe, Co, V, Nb, Ta, Zr, Cu, Zn, Mo, V, Cr, W, Mn and Re.

The catalyst precursors can be inorganic or organometallic compounds. Non-limiting examples of catalyst precursors include ferrocene, nickelocene, cobaltcene, ferric acetylacetonate, iron trihalide, ferric nitrate, iron carbonyl, iron oxide, iron phosphate, iron sulfate, iron molybdate, iron titanate, iron acetate, nickel hydroxide, nickel oxide, nickel sulfamate, nickel stearate, nickel molybdate, nickel carbonyl, nickelous nitrate, nickel halide, nickelous sulfate, cobalt carbonyl, cobalt acetate, cobalt acetylacetonate, cobalt carbonate, cobalt hydroxide, cobalt oxide, cobalt stearate, cobaltous nitrate, cobaltous sulfate, cobalt halide and combinations thereof. In one embodiment, the catalyst precursors are selected from the group consisting of ferrocene, nickelocene, cobalt carbonyl, iron trichloride, iron carbonyl, cobaltous sulfate and combinations thereof. In another embodiment, the catalyst precursor is a mixture of ferrocene and nickelcene.

The reduction of the catalyst precursors can be carried out by reacting the catalyst precursors with a reductant. The reductant can be either a solid or gaseous reducing agent. Preferably, the reducing agent is a gas, such as hydrogen, CO or a mixture thereof. The reducing gas is optionally mixed with an inert gas. In one embodiment, the reducing agent is hydrogen or a mixture of hydrogen with an inert gas. The inert gas can be nitrogen, argon, helium or a mixture thereof. The hydrogen can be present in the mixture from about 0.1% to about 99%. For example, the mixed gas can contain hydrogen of about 0.1, 0.2, 0.3, 0.4, 0.5, 0.6, 0.7, 0.8, 0.9, 1, 2, 3, 4, 5, 6, 7, 8, 9, 10, 20, 30, 40 50, 60, 70, 80, 90, 95 or 99% by volume. The reduction is typically carried out by passing through a hydrogen or hydrogen containing gas to the metal catalyst precursors at a temperature from about 500° C. to about 900° C. For example, the reduction of the catalyst precursors can be carried out in situ within a reactor to generate the active metal nanoparticles.

The carbon nanotubes can be synthesized by reacting the catalysts, metal nanoparticles, with a hydrocarbon compound at a temperature from about 450 to about 900° C. In one embodiment, the reaction can be carried out at a temperature of about 500° C., 600° C., 700° C., 730° C., 800° C., or 900° C.

In another aspect, the present invention provides a method for preparing a carbon-nanotube yarn or a carbon-nanotube film. The method includes forming an aligned carbon-nanotube array on a substrate and drawing the array of carbon nanotubes to form a carbon-nanotube yarn or film. In one embodiment, the array of aligned carbon nanotubes is attached to the substrate. In another embodiment, the array of aligned carbon nanotubes is separated from the substrate. In one embodiment, the formation of aligned carbon nanotubes further include providing a reactor having a substrate disposed in the reactor for growing carbon nanotubes and reacting a carbon source and a catalyst in the reactor under conditions sufficient to form an array of aligned carbon nanotubes on the substrate, wherein the substrate has a radius of curvature of at least about 10 μm.

In one embodiment, the carbon-nanotube yarns prepared are carbon-nanotube yarns of more than several hundred meters long, wherein the orientations of the carbon nanotubes remain substantially the same. For example, the carbon-nanotube yarns have a length greater than 100, 200, 300, 400, 500 or 1000 meters.

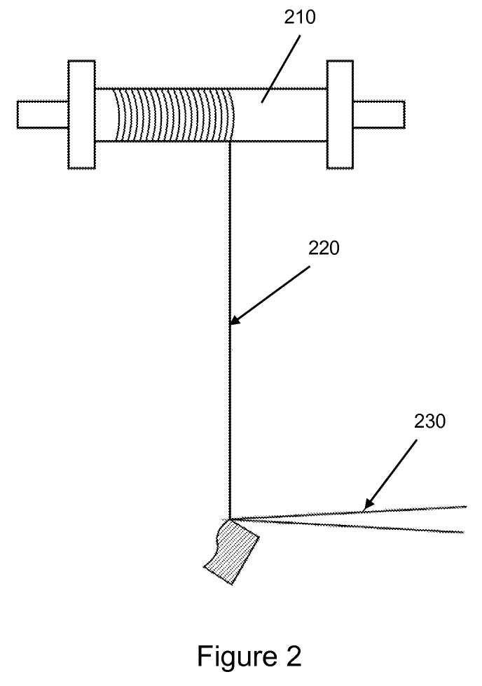

According to an embodiment of the invention, carbon-nanotube yarn string 220 can be drawn out with a drawing tool having a sharp tip, such as a tweezer 230. Alternatively, a forcep, a pincer, a nipper, a tong and other hand tool can also be used. Carbon-nanotube yarn 220 can be coiled onto a bobbin 210 by hand or using a motor (see, FIG. 2). Carbon nanotube yarn can be formed by drawing a bundle of carbon nanotubes continuously in the pulling direction. Carbon-nanotube film can be formed by drawing a multiple bundles of carbon nanotubes from the aligned nanotube array using a standard drawing tool.

The present invention also contemplates a method of preparing carbon-nanotube composite materials. The method includes contacting a carbon-nanotube yarn or film with a polymer under conditions sufficient to form a carbon-nanotube composite, wherein the polymer is deposited on the carbon-nanotube yarn. In one embodiment, the polymer is dissolved in a solvent to form a solution, carbon-nanotube yarn or film is dipped into the solution to form a polymer coated nanocomposite material. The solvent used can be water, common organic solvents or a mixture thereof. Non-limiting exemplary organic solvents include less polar hydrocarbon solvent, such as pentanes, hexanes, petroleum ether, benzene and toluene; and polar solvents, such as ether, tetrahydrofuran, dichloraomethane, chloroform, dichloroethane, dimethysulfoxide, dimethylformamide, dimethylacetamide, dioxane, methanol, ethanol, ethyl acetate, acetonitrile, acetone and carbon tetrachloride. In another embodiment, the nanotubes yarn or film is mechanically blended with the polymer. In yet another embodiment, the carbon-nanotube yarn or film is mixed with the polymer under a melt-processing condition. Various techniques are suitable for the formation of nanocomposite materials. These include injection molding, extrusion, blow molding, thermoforming, rotational molding, cast and encapsulation and calendaring. The polymers used in the melt-processing are preferably thermoplastic polymers. In still another embodiment, the composite is formed by conducting the polymerization in the presence of a carbon-nanotube yarn or film.

Both naturally occurring polymers and synthetic polymers and/or copolymers can be used for the preparation of carbon-nanotube composites. Naturally occurring polymers include, but are not limited to, natural rubber, proteins, carbohydrates, nucleic acids. Synthetic polymers include condensation polymers and addition polymers, which can be either thermoplastic or thermoset polymers. Thermoplastic condensation polymers include, but are not limited to, polysulfones, polyamides, polycarbonates, polyphenylene oxides, polysulfides, polyether ether ketone, polyether sulfones, polyamide-imides, polyetherimides, polyimides, polyarylates, and liquid crystalline polyesters. Thermoplastic addition polymers include, but are not limited to, homopolymers and copolymers of a monomer of formula I:

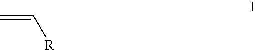

where R is a substituted or unsubstituted alkyl, substituted or unsubstituted heteroalkyl, substituted or unsubstituted aryl, substituted or unsubstituted heteroaryl, halogen, —CN, —SR^{a}, —OR^{a}, —COOR^{a}, —COOH, —CONHR^{a}, —CONR^{a}, —OC(O)R^{a}, —OC(O)OR^{a}, —OC(O)NH₂, OC(O)(R^{a})₂, —OC(O)NHR^{a}, —HR^{a}, —N(R^{a})₂, —NHC(O)R^{a} or —NR^{a}C(O) R^{a}, where R^{a} is unsubstituted alkyl or unsubstituted aryl.

Substituents for the alkyl can be a variety of groups selected from: -halogen, =0, —OR′, —NR′R″, —SR′, —SiR′R″R′″—OC(O)R′, —C(O)R′, —CO₂R′, —CONR′R″, —OC(O)NR′R″, —NR″ C(O)R′, —NR′—C(O)NR″R′″-NR″ C(O)₂R′, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, —CN and —NO₂ in a number ranging from zero to (2 m′+1), where m′ is the total number of carbon atoms in such radical. R′, R″ and R′″ each independently refer to hydrogen, unsubstituted Q-8 alkyl, unsubstituted heteroalkyl, unsubstituted aryl, aryl substituted with 1-3 halogens, unsubstituted C₁₋₈ alkyl, d-8 alkoxy or C1-S thioalkoxy groups, or unsubstituted aryl-Ĉ alkyl groups.

Substituents for the aryl and heteroaryl groups are varied and are generally selected from: -halogen, —OR′, —OC(O)R′, —NR′R″, —SR′, —R′, —CN, —NO₂, —CO₂R′, —CONR′R″, —C(O)R′, —OC(O)NR′R″, —NR″C(O)R′, —NR″C(O)₂R′, —NR′—C(O)NR″R′″, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, —N₃, perfluoro(C₁-C₄)alkoxy, and perfluoro(C₁-C₄)alkyl, in a number ranging from zero to the total number of open valences on the aromatic ring system; and where R′, R″ and R′″ are each independently selected from hydrogen, C₁₋₈ alkyl, unsubstituted aryl and heteroaryl, (unsubstituted aryl)-C₁₋₄ alkyl, and unsubstituted aryloxy-C₁₋₁₄ alkyl.

Non-limiting exemplary thermoplastic polyolefins include polyethylene, polypropylenes, polystyrenes, polyvinyl chloride, polyacrylates, polymethacrylate, polyacrylamide, polymethacrylamide, polyacrylonitrile, poly(N-vinylcarbazole), poly(N-vinylpyrrolidine), poly(vinyl ether), polyvinyl alcohol), poly(vinylidene fluoride) and polyvinyl fluoride).

### EXAMPLES

### Example 1

This example illustrates the synthesis of vertical aligned carbon-nanotube arrays from floating catalyst processes and drawn spin carbon-nanotube yarns from carbon-nanotube arrays grown on a silica plate substrate.

### Preparation of Vertical Aligned Carbon-Nanotube Arrays on a Plate Substrate

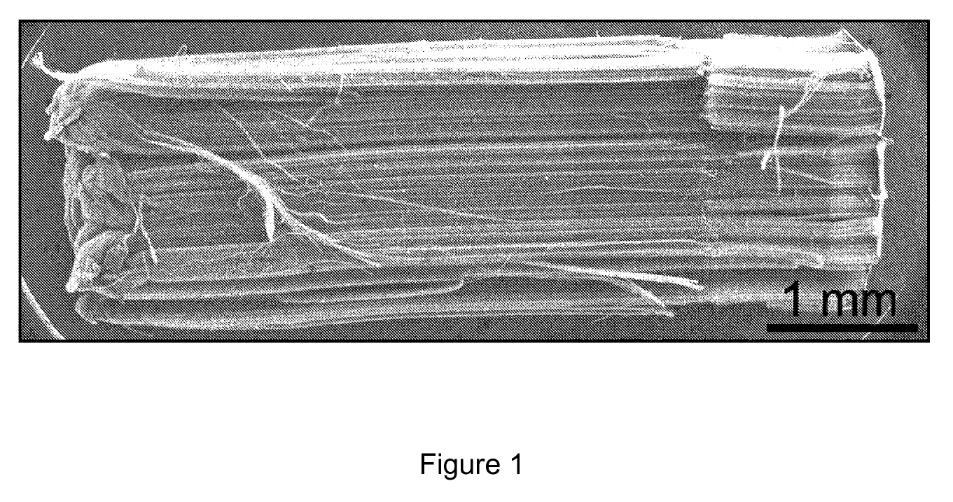

A silica plate with a size of 25 mm×25 mm×1 mm was put into a fixed-bed reactor as a growth substrate. The temperature of the reactor was increased to 900° C. at an atmosphere of Ar and H₂ and kept constant. A solution of ferrocene/cyclohexance was injected into the reactor. The ferrocene was decomposed when the temperature was above 470° C. The catalytic iron nanoparticles were formed in situ, and were transferred onto the silica plate substrate to catalyze the decomposition of propylene and the growth of carbon-nanotube arrays. As shown in FIG. 1, vertical aligned carbon-nanotube array of 5.4 mm in length were obtained on the silica plate after 2.5 h of growth time.

Preparation of Carbon-Nanotube Yarn Having a Diameter of about 1 μm

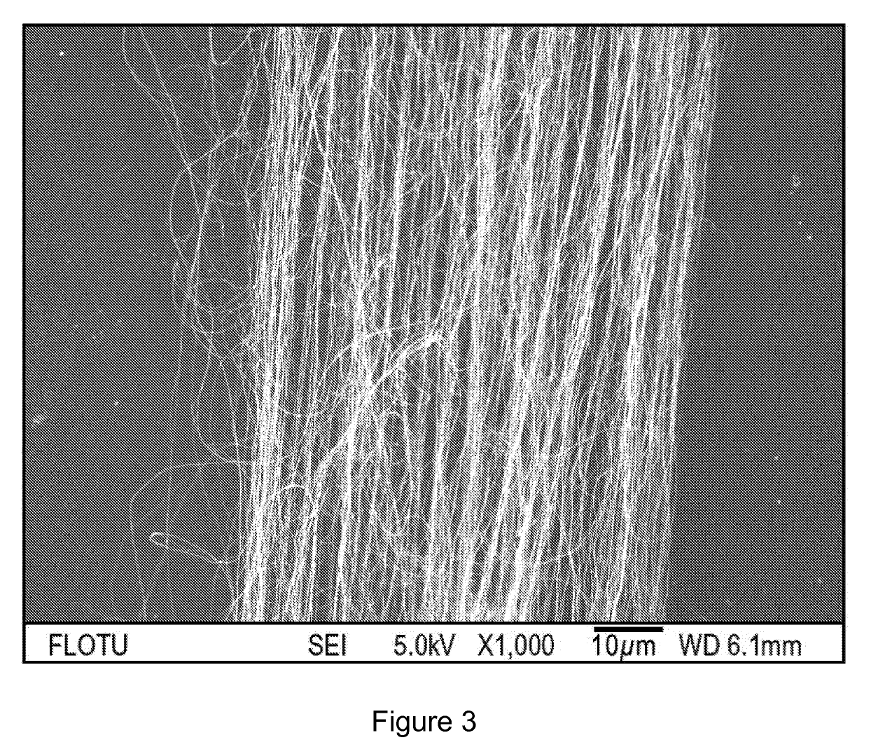

The substrate and the carbon-nanotube array thereon were removed from the reactor. The carbon-nanotube arrays were remained on the substrate. A bundle of carbon-nanotube array having a diameter of about 1 μm was selected using a tweezer. A carbon-nanotube yarn was drawn from the array. Due to the connection among carbon-nanotube bundles, the carbon-nanotube yarn was continuous spinning from the array at a rate of 0.1 m/s (FIG. 2). After several minutes of drawing, the carbon-nanotube yarn with a diameter of 1 μm and a length of several meters was obtained (FIG. 3).

During the drawing process, the force used for drawing was related to the bundle size of carbon-nanotube array. If the carbon-nanotube yarn is thicker, then larger drawing force is needed. The diameter of the carbon-nanotube yarn can be modulated by the initial carbon-nanotube yarns. The obtained carbon nanotube yarn constituted cross-linked or twined carbon nanotubes with good alignment.

After twist of the carbon-nanotube yarn, the strength of the yarn was improved. If the carbon-nanotube yarn was dipped into the PVA solution, then the surface of the carbon-nanotube yarn was coated by PVA polymer. A carbon-nanotube yarn/PVA composite was formed.

### Example 2

This example illustrates the synthesis of vertical aligned carbon-nanotube arrays from floating catalyst process and the spin carbon-nanotube yarn from carbon-nanotube arrays grown on the spherical substrate.

### Preparation of Vertical Aligned Carbon-Nanotube Arrays on a Spherical Substrate

A moving bed reactor was loaded with SiO₂/ZrO₂ spheres with a diameter of 1 mm as the growth substrate. The temperature of the reactor was increased to 750° C. at an atmosphere of N₂ and H₂ and kept at constant. A solution of nickelocene-ferrocene dissolved in cyclohexane was injected into the reactor. The nickelocene and ferrocene decomposed into metal atoms and formed clusters of nanoparticles, which are active catalysts. The catalyst nanoparticles were formed in situ, and transferred onto the silica plate substrate to catalyze the decomposition of propylene and the growth of carbon-nanotube arrays. A vertical aligned carbon-nanotube array of 0.5 mm in length was grown on the SiO2AZrO2 spheres after 1.0 h of reaction.

Preparation of Carbon-Nanotube Yarn Having a Diameter of about 100 μm

The substrate and the carbon-nanotube array thereon were taken out of the reactor. The carbon-nanotube array was separated from the substrate. A bundle of carbon-nanotube array having a diameter of about 100 μm was selected using a tweezer. A carbon-nanotube yarn was drawn from the array. Due to the connection among carbon-nanotube bundles, the carbon-nanotube yarn was continuous spinning from the array at a rate of 0.01 m/s. After several minutes of drawing, the carbon-nanotube, yarn with a diameter of 100 μm and a length of sever meters was obtained.

### Example 3

This example illustrates the synthesis of vertical aligned carbon-nanotube arrays from floating catalyst processes and the spin carbon-nanotube yarn from carbon-nanotube arrays grown on a fibrous substrate. Preparation of vertical aligned carbon-nanotube arrays on a fibrous substrate

To a moving bed reactor was added quartz fiber with a diameter of 10 μm as the growth substrate. The temperature of the reactor was increased to 750° C. at an atmosphere of Ar and H₂ and kept at constant. A solution of cobalt carbonyl dissolved in benzene was injected into the reactor. The cobalt carbonyl decomposed into metal atoms and formed clusters of nanoparticles, which are active catalysts. The cobalt catalyst nanoparticles were formed in situ, and transferred onto the quartz substrate to catalyze the decomposition of propylene and the growth of carbon-nanotube arrays. A vertical aligned carbon-nanotube array of 0.3 mm in length was grown on the quartz fiber after 0.8 h of reaction.

Preparation of Carbon-Nanotube Yarn Having a Diameter of about 0.8 μm

The substrate and the carbon-nanotube array thereon were removed from the reactor. The carbon-nanotube array was remained on the substrate. A bundle of carbon-nanotube array having a diameter of about 0.8 μm was selected using a tweezer. A carbon-nanotube yarn was drawn from the array. Due to the connection among carbon-nanotube bundles, the carbon-nanotube yarn was continuous spinning from the array at a rate of 0.1 m/s. After several minutes of drawing, the carbon-nanotube yarn with a diameter of 0.8 μm and a length of half meter was obtained.

### Example 4

This example illustrates the synthesis of vertical aligned carbon-nanotube arrays from floating catalyst processes and the spin carbon-nanotube yarn from carbon-nanotube arrays grown on quartz particle substrates.

### Preparation of Vertical Aligned Carbon-Nanotube Arrays on a Quartz Particle Substrate

A fluidized-bed reactor was loaded with quartz particles with a diameter of 25 μm as the growth substrate. The temperature of the reactor was increased to 600° C. at an atmosphere of N₂ and H₂ and kept at constant. A vapor of FeCl₃ was injected into the reactor. The FeCl₃ decomposed into metal atoms and formed clusters of nanoparticles, which are active catalysts. The iron catalyst nanoparticles were formed in situ, and transferred onto the quartz particle surface to catalyze the decomposition of propylene and the growth of carbon-nanotube arrays on the quartz particle surface. A vertical aligned carbon-nanotube array of 0.1 mm in length was grown on the quartz particle after 1 h of reaction.

Preparation of Carbon-Nanotube Yarn Having a Diameter of about 10 μm

The substrate and the carbon-nanotube array thereon were removed from the reactor. The carbon-nanotube array was remained on the substrate. A bundle of carbon-nanotube array having a diameter of about 10 μm was selected using a tweezer. A carbon-nanotube yarn was drawn from the array. Due to the connection among carbon-nanotube bundles, the carbon-nanotube yarn was continuous spinning from the array at a rate of 0.1 cm/s. After several minutes of drawing, the carbon-nanotube yarn with a diameter of 0.8 μm and a length of several meters was obtained.

### Example 5

This example illustrates the preparation of vertical aligned carbon-nanotube arrays from floating catalyst processes and the spin carbon-nanotube film from carbon-nanotube arrays grown on a quartz tube wall.

### Preparation of Vertical Aligned Carbon-Nanotube Arrays on a Quartz Tube Wall

A fixed-bed reactor was loaded with a quartz tube with a diameter of 25 mm as the growth substrate. The temperature of the reactor was increased to 700° C. at an atmosphere of He and H₂. A vapor of Fe(CO)5 was injected into the reactor. The Fe(CO)5 decomposed into metal atoms and formed clusters of nanoparticles, which are active catalysts. The iron catalyst nanoparticles were formed in situ, and transferred onto the quartz tube surface to catalyze the decomposition of ethane and the growth of carbon-nanotube arrays on the quartz tube surface. A vertical aligned carbon-nanotube array of 0.1 mm in length grown on the quartz tube surface was obtained after 1 hour of reaction. Preparation of a carbon-nanotube film The substrate was taken out of the reactor and the carbon-nanotube arrays were separated from the substrate. A bundle of carbon-nanotube arrays were selected using a 3M™ paper. A carbon-nanotube film was drawn from the array. Due to the connection among carbon-nanotube bundles, the carbon-nanotube film can be continuous spinning from the array with a rate of 0.1 cm/s. After several minutes drawing, the carbon-nanotube film having a dimension of 1 cm in width, several meters in length and a thickness of 100 nm was obtained.

### Example 6

This example illustrates the preparation of vertical aligned carbon-nanotube arrays from floating catalyst processes and the spin carbon-nanotube film from carbon-nanotube arrays grown on the quartz tube wall.

Preparation of Vertical Aligned Carbon-Nanotube Arrays on a Quartz Tube Wall from Benzene

A fixed-bed reactor was loaded with a quartz tube with a diameter of 100 mm as the growth substrate. The temperature of the reactor was increased to 800° C. at an atmosphere of Ar and H₂. A vapor Of Fe(CO)₅ was injected into the reactor. The temperature was kept at 800° C. A solution of ferrocene/benzene solution vapor was injected. The ferrocene was decomposed into metal atoms, which were clustered into nanoparticles with catalytic activities. The iron catalyst nanoparticles were formed in situ and transferred to the quartz surface to catalyze the decomposition of benzene and growth of carbon-nanotube arrays. A vertical aligned carbon-nanotube array of 0.6 mm in length was growth on the quartz wall after 0.5 h growth. The inlet of the feeding was stopped and cool down to 300° C. and the reactor was heated again to 800° C. again and a ferrocene/benzene solution was injected into the reactor and reacted for another 1 hr. Another carbon-nanotube array of 1.1 mm in length was grown at the top of the previous array. The cumulative height of the carbon-nanotube arrays obtained was about 1.7 mm.

### Preparation of a Carbon-Nanotube Film

The substrate was taken out of the reactor and the carbon-nanotube arrays were separated from the substrate. A bundle of carbon-nanotube arrays were selected using 3M™ paper. A carbon-nanotube film was drawn from the array. Due to the connection among carbon-nanotube bundles, the carbon-nanotube film can be continuous spinning from the array with a rate of 0.3 cm/s. After several minutes drawing, carbon-nanotube film having a height of 500 nm, a width of 3.0 cm and a length of several meters was obtained.

### Example 7

This example illustrates the synthesis of vertical aligned carbon-nanotube arrays from floating catalyst processes and the spin carbon-nanotube film from carbon-nanotube arrays grown on the quartz particles.

### Preparation of Vertical Aligned Carbon-Nanotube Arrays on a Quartz Particle Substrate

A horizontal drum reactor was loaded with quartz particles with a diameter of 2 mm as the growth substrate. The temperature of the reactor was increased to 730° C. at an atmosphere of Ar and H₂ and kept at constant. A solution of cobalt sulfate/ethanol solution was injected into the reactor. The cobalt sulfate decomposed into metal atoms and formed clusters of nanoparticles, which are active catalysts. The cobalt catalyst nanoparticles were formed in situ, and transferred onto the quartz particle surface to catalyze the decomposition of butadiene and the growth of carbon-nanotube arrays on the quartz particle surface. A vertical aligned carbon-nanotube array of 0.1 mm in length was grown on the quartz particle after 0.5 h of growth reaction.

### Preparation of a Carbon-Nanotube Film

The substrate and the carbon-nanotube array were removed from the reactor. The carbon-nanotube array was separated from the substrate. A bundle of carbon-nanotube array having a diameter of about 30 μm was selected using a tweezer. A carbon-nanotube yarn was drawn from the array. Due to the connection among carbon-nanotube bundles, the carbon-nanotube yarn was continuous spinning from the array at a rate of 0.5 cm/s. After 4 minutes of drawing, the carbon-nanotube yarn with a diameter of 30 μm and a length of several meters was obtained.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. All publications, patents, and patent applications cited herein are hereby incorporated by reference in their entirety for all purposes.

What is claimed is:

1. A method for preparing an aligned carbon-nanotube array, comprising:
placing a non-flat substrate in a reactor, wherein said non-flat substrate has a radius of curvature of at least about 10 μm; and
reacting a carbon source and a catalyst in the reactor to form an array of substantially aligned carbon nanotubes on the non-flat substrate.

2. The method of claim 1, wherein the non-flat substrate comprises a material selected from the group consisting of silicon, silica, alumina, zirconia, magnesia, quartz and combinations thereof.

3. The method of claim 1, wherein the non-flat substrate has a shape selected from the group consisting of plate-like, tubular, cubical, spherical, and combinations thereof.

4. The method of claim 1, wherein the reactor is selected from the group consisting of a fluidized-bed reactor, a spout-bed reactor, a horizontal drum, a moving-bed reactor, a fixed-bed reactor, and a combination thereof.

5. The method of claim 1, wherein the catalyst comprises metal nanoparticles.

6. The method of claim 5, wherein the metal nanoparticles comprise iron and optionally at least one metal selected from the group consisting of Ni, Co, V, Nb, Mo, V, Cr, W, Mn, and Re.

7. The method of claim 5, wherein the metal nanoparticles comprise nickel and optionally at least one metal selected from the group consisting of Fe, Co, V, Nb, Mo, V, Cr, W, Mn, and Re.

8. The method of claim 5, wherein the catalyst is prepared by contacting a catalyst precursor with a reducing gas.

9. The method of claim 8, wherein said reducing gas comprising hydrogen, or an inert gas, or a combination thereof.

10. The method of claim 9, wherein the inert gas is selected from the group consisting of argon, nitrogen, helium and mixtures thereof.

11. The method of claim 8, wherein the catalyst precursor is selected from the group consisting of ferrocene, nickelocene, cobaltcene, ferric acetylacetonate, iron carbonyl, nickel carbonyl, cobalt carbonyl, iron trihalide, ferric nitrate, cobaltous nitrate, nickelous nitrate, nickelous sulfate, cobaltous sulfate, nickel halide, cobalt halide and combinations thereof.

12. A method for preparing a carbon-nanotube yarn, said method comprising:
forming an array of substantially aligned carbon-nanotubes on a non-flat substrate, wherein the non-flat substrate has a radius of curvature of at least about 10 μm; and
drawing a bundle of carbon nanotubes from said array of substantially aligned carbon nanotubes to form a carbon-nanotube yarn.

13. The method of claim 12, wherein said carbon-nanotube yarn has a diameter of at least about 0.1 μm and a length of at least 1 cm.

14. The method of claim 13, wherein the carbon-nanotube yarn has a length greater than 300 meters.

15. The method of claim 12, further comprising separating the array of substantially aligned carbon-nanotubes from said non-flat substrate.

16. A method for preparing a carbon-nanotube film, said method comprising:
forming a array of substantially aligned carbon-nanotubes on a non-flat substrate, wherein said non-flat substrate has a radius of curvature of at least about 10 μm;
drawing a plurality of bundles of carbon nanotubes from said array of substantially aligned carbon nanotubes, wherein the plurality of bundles of carbon nanotubes are connected; and
forming a carbon-nanotube film with the plurality of bundles of carbon nanotubes.

17. The method of claim 16, wherein said carbon nanotube film has a width of at least about 10 μm, a length of at least about 1 cm, and a thickness of about 30 nm to about 900 nm.

18. The method of claim 16, further comprising separating the array of substantially aligned carbon-nanotubes from said non-flat substrate.

19. The method of claim 16, wherein the step of forming comprises:
placing the non-flat substrate in a reactor, wherein said non-flat substrate has a radius of curvature of at least about 10 μm; and
reacting a carbon source and a catalyst in the reactor to form an array of substantially aligned carbon nanotubes on the non-flat substrate.

20. The method of claim 19, wherein the carbon source is selected from the group consisting of C₂₋₁₂ alkene, C₂₋₁₂ alkyne, arene having from 6 to 14 ring carbons and mixtures thereof, wherein the arene is optionally substituted with from 1-6 C₁₋₆ alkyl.

21. The method of claim 20, wherein the arene is selected from the group consisting of benzene, naphthalene, anthracene, phenanthrene, and mixtures thereof.

22. The method of claim 19, wherein the reaction is carried out at a temperature from about 500° C. to about 950° C.

23. The method of claim 16, wherein the reactor is selected from the group consisting of a fluidized-bed reactor, a spout-bed reactor, a horizontal drum, a moving-bed reactor, a fixed-bed reactor, and a combination thereof.

24. The method of claim 16, wherein the non-flat substrate comprises a material selected from the group consisting of silicon, silica, alumina, zirconia, magnesia, quartz and combinations thereof.

25. The method of claim 16, wherein the non-flat substrate has a shape selected from the group consisting of plate-like, tubular, cubical, spherical, and combinations thereof.

26. The method of claim 16, wherein the catalyst comprises metal nanoparticles.

27. A carbon-nanotube structure, comprising:
an array of substantially aligned carbon nanotubes deposited on a non-flat substrate, wherein said non-flat substrate has a radius of curvature of at least about 10 μm.

28. The structure of claim 27, wherein the non-flat substrate is selected from the group consisting of a silica plate, a SiO₂/ZrO₂ sphere, a quartz fiber, a quartz particle, a quartz tube, and an alumina plate.

29. A carbon-nanotube film, comprising:
an array of substantially aligned carbon-nanotube yarns, which forms a film having a width of greater than about 10 μm, a length of at least about 1 cm, and a thickness of about 30 nm to about 900 nm.

30. A carbon-nanotube composite, comprising:
a carbon-nanotube yarn or a carbon-nanotube film; and
a polymer in contact with the carbon-nanotube yarn or the carbon-nanotube film.

31. The carbon-nanotube composite of claim 30, wherein the carbon-nanotube yarn has a diameter greater than about 0.1 m and a length of at least 1 cm.

32. The carbon-nanotube composite of claim 30, wherein the carbon-nanotube film has a width of greater than about 10 μm, a length of at least about 1 cm, and a thickness of about 30 nm to about 900 nm.

33. The carbon-nanotube composite of claim 30, wherein the polymer is a natural polymer or a synthetic polymer.

34. The carbon-nanotube composite of claim 33, wherein the natural polymer is selected from the group consisting of natural rubber, proteins, carbohydrates, and nucleic acids.

35. The carbon-nanotube composite of claim 33, wherein the synthetic polymer is a condensation polymer or an addition polymer.
